(19) United States
(12) Patent Application Publication
(10) Pub. No.: US 2018/0248178 A1
(43) Pub. Date: Aug. 30, 2018

(54) ANODE MATERIALS FOR LITHIUM BATTERY OF IMPROVED TEMPERATURE PERFORMANCE

(71) Applicant: Nano and Advanced Materials Institute Limited, Shatin (HK)

(72) Inventors: Chung Pui Chan, Hong Kong (HK); Yeming Xu, Hong Kong (HK); Chao Cai, Hong Kong (HK); Kowk Keung Paul Ho, Hong Kong (HK)

(21) Appl. No.: 15/441,475

(22) Filed: Feb. 24, 2017

(51) Int. Cl. H01M 4/36; H01M 10/0525; H01M 4/583; H01M 4/04; H01M 4/485

(52) U.S. Cl. CPC H01M 4/366; H01M 10/0525; H01M 2004/027; H01M 4/0402; H01M 4/485; H01M 4/583

(57) ABSTRACT

Disclosed are composite anodes for a lithium ion battery containing carbon material core particles and a coating layer of LTO particles over the carbon material core particles, the coating layer of LTO particles at least partially covering the carbon material core particles. Also disclosed are anodes for a lithium ion battery containing activating treated surface modified graphite particles, wherein at least one of an inorganic acid or an oxidizing agent is used to treat and modify the surface of the graphite particles.

### TECHNICAL FIELD

Disclosed are surface modification technologies for carbonaceous anode materials in lithium ion batteries that improve the rate capability and safety at low and high temperatures.

### BACKGROUND

Lithium ion batteries (LIBs) are widely used in different fields such as electronic devices, electric tools, medical equipment and electric vehicles. However, common LIBs have a relatively narrow operating temperature which limits its applications in extreme environments. For vehicle and certain defense applications, operation temperature at −30° C. or below is required, although LIBs generally exhibit poor performance at this temperature range. Generally speaking, both the power and energy capacity of a LIB are significantly decreased when the temperature drops to −20° C. (J. Power Sources, 2003, 117, 170, J. Power Sources, 2004, 138, 288).

On the other hand, the related safety issues as well as the cycling stability of LIB at high temperature are the main problems receiving attention. For this reason, a lot of research is carried out examining thermal stabilities in the LIB cells (J. Power Sources, 2001, 87, 97, J. Power Source, 1999, 8, 81).

Non-carbon type anodes have been explored for LIB to overcome the problems of carbonaceous materials. For instance, as one of the most promising candidates to be commercialized, spinel Li₄Ti₅O₁₂ (LTO) anode has a theoretical capacity of 175 mAh/g with excellent cyclability due to its zero volume change during the charging/discharging cycles. Unfortunately, due to the low intrinsic electronic conductivity, low energy density, and high fabrication cost, the LTO anode is still not considered the most preferable choice for the power LIB industries in large-scale/commercial applications.

### SUMMARY

The following presents a simplified summary of the invention in order to provide a basic understanding of some aspects of the invention. This summary is not an extensive overview of the invention. It is intended to neither identify key or critical elements of the invention nor delineate the scope of the invention. Rather, the sole purpose of this summary is to present some concepts of the invention in a simplified form as a prelude to the more detailed description that is presented hereinafter.

The subject invention provides surface modification technologies for carbonaceous anode materials in lithium ion batteries (LIB), that improve at least one of the rate capability and safety at low and high temperatures.

One aspect of the invention relates to a composite anode for a lithium ion battery containing carbon material core particles and a coating layer of LTO particles over the carbon material core particles, the coating layer of LTO particles at least partially covering the carbon material core particles.

Another aspect of the invention relates to a method of making a composite anode for a lithium ion battery involving coating carbon material particles with a LTO precursor and calcining the LTO precursor coated carbon material particles under an inert atmosphere to provide the composite anode.

Yet another aspect of the invention relates to an anode for a lithium ion battery containing activating treated surface modified graphite particles, wherein at least one of an inorganic acid or an oxidizing agent is used to treat and modify the surface of the graphite particles.

Still yet another aspect of the invention relates to lithium ion batteries containing the anodes described herein.

To the accomplishment of the foregoing and related ends, the invention comprises the features hereinafter fully described and particularly pointed out in the claims. The following description and the annexed drawings set forth in detail certain illustrative aspects and implementations of the invention. These are indicative, however, of but a few of the various ways in which the principles of the invention may be employed. Other objects, advantages and novel features of the invention will become apparent from the following detailed description of the invention when considered in conjunction with the drawings.

### BRIEF SUMMARY OF THE DRAWINGS

FIGS. 1(a)-1(c) show SEM images of (a) artificial graphite, (b) 5 wt % LTO capped graphite, and (c) graphite treated by nitric acid.

FIGS. 2(a)-2(b) show (a) EDX analysis of 5 wt % LTO capped graphite and (b) XRD of 5 wt % LTO capped graphite.

FIG. 3 shows Raman spectra of artificial graphite and graphite treated by nitric acid

FIG. 4 shows initial columbic efficiencies of full cells with artificial graphite, 5 wt % LTO capped graphite and graphite treated by nitric acid.

FIG. 5 shows specific capacity of artificial graphite, 5 wt % LTO capped graphite and graphite treated by nitric acid.

FIG. 6 shows retention performance of full cells in the form of pouch cell with artificial graphite, 5 wt % LTO capped graphite and graphite treated by nitric acid as anode under 55° C. and the rate of 10.

FIG. 7 shows the batteries retention after 300 charging-discharging cycles under 55° C. at the rate of 1C.

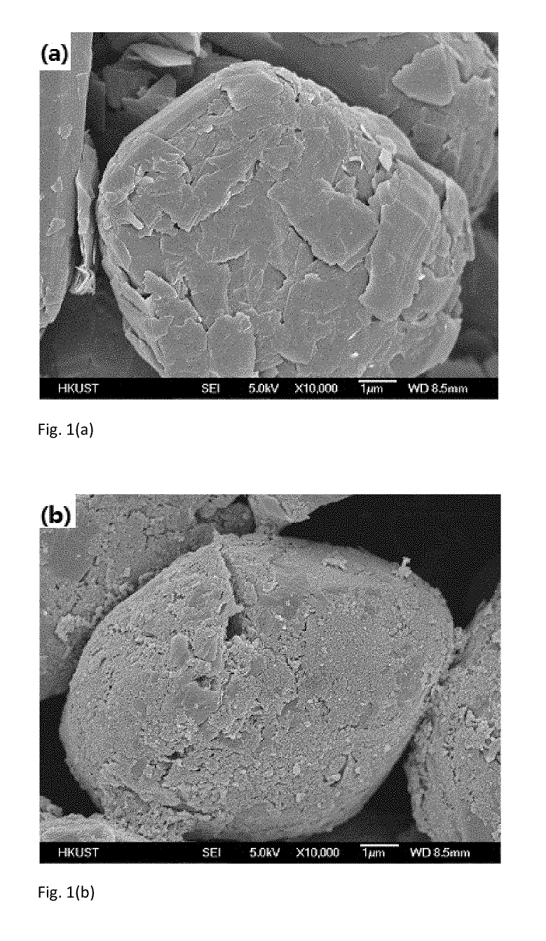

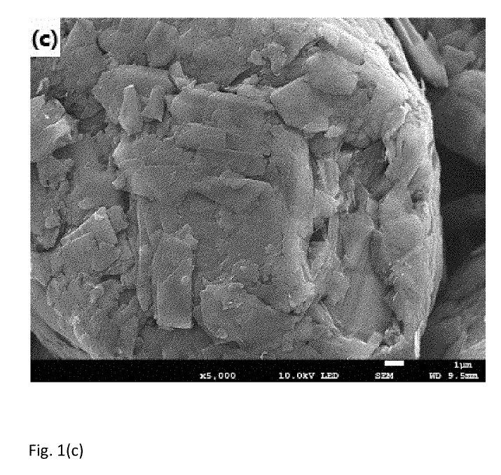

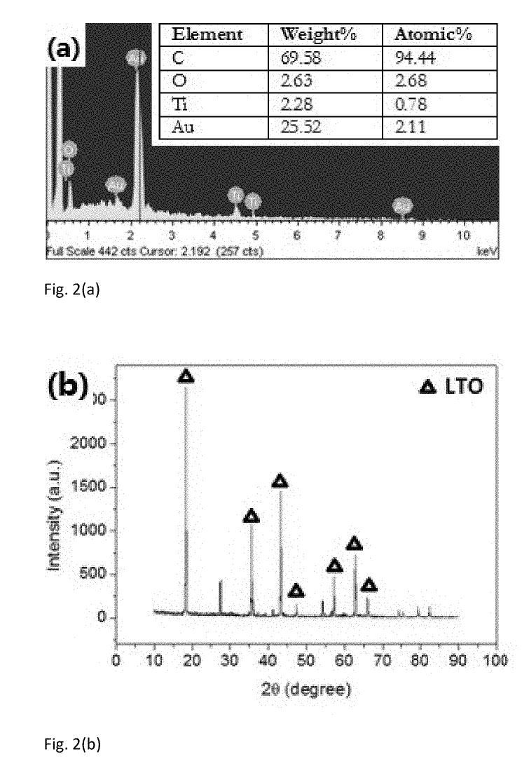

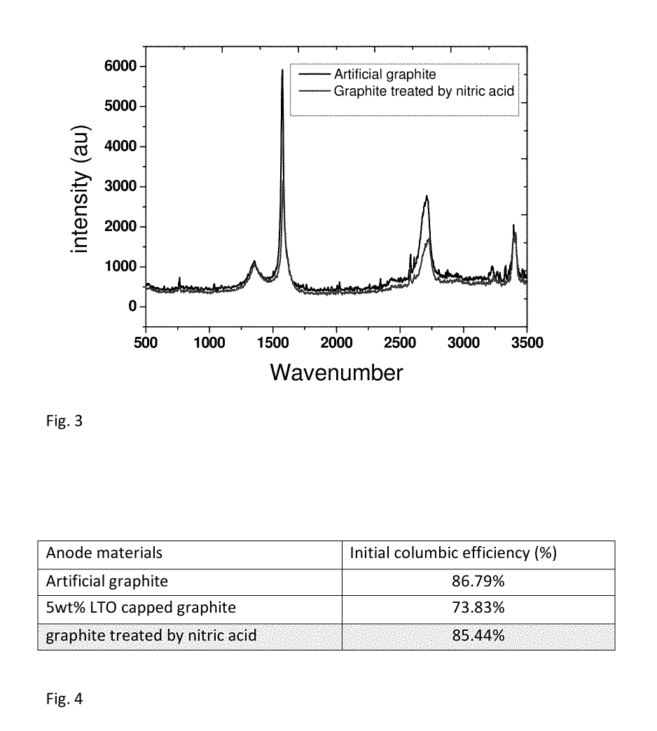

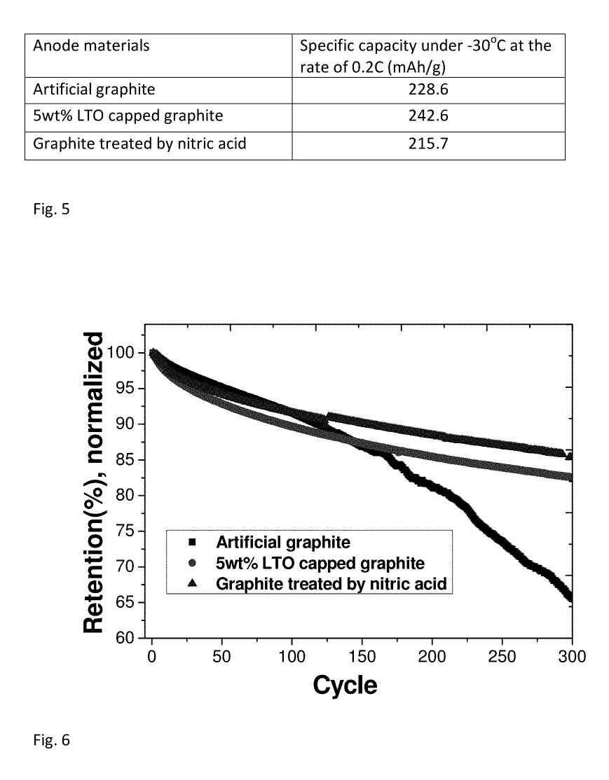

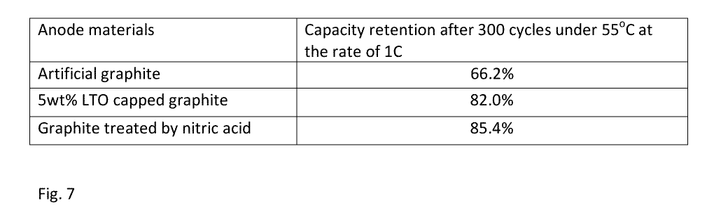

### DETAILED DESCRIPTION

The description herein relates to surface modification technologies for carbonaceous anode materials in LIB, to improve the rate capability and safety at low and high temperatures. This disclosure delivers improved anode materials, formulations, and application processes. For example, the improved anode materials can achieve a high specific capacity at −30° C., and over 80% capacity retention after 300 cycles at 55° C.

One aspect of the disclosure involves a composite anode for a LIB containing a coating layer of LTO particles at least partially covering carbon material core particles.

The carbon material core particles contain a carbonaceous material suitable for serving as an LIB anode material. Non-limiting examples of carbon material for the carbon material core particles include acetylene black, carbon black, and graphite. Graphite includes one or more of natural graphite and synthetic graphites such as electrographite or artificial graphite.

The carbon material core particles have a relatively small size which contributes to the beneficial attributes of the LIBs containing the composite anode. In one embodiment, the carbon material core particles have an average diameter from about 500 nm to about 50 μm. In another embodiment, the carbon material core particles have an average diameter from about 1 μm to about 40 μm. In yet another embodiment, the carbon material core particles have an average diameter from about 5 μm to about 25 μm.

In order for the LIBs to attain the improved characteristics, such as the improved high/low temperature performance and/or improved cycling, the carbon material core particles have a coating layer of LTO particles at least partially covering the carbon material core particles. In one embodiment, the coating layer of LTO particles covers at least 50% of the surface area of the carbon material core particles. In another embodiment, the coating layer of LTO particles covers at least 75% of the surface area of the carbon material core particles. In yet another embodiment, the coating layer of LTO particles covers at least 90% of the surface area of the carbon material core particles. In still yet another embodiment, the coating layer of LTO particles covers substantially the entire surface area of the carbon material core particles.

As a coating, the LTO particles have a size that is much smaller than the size of the carbon material core particles. In one embodiment, the LTO particles have an average size that is at least about 1/10^{th} smaller than the average size of the carbon material core particles. In another embodiment, the LTO particles have an average size that is at least about 1/20^{th} smaller than the average size of the carbon material core particles.

The LTO particles have a size suitable size so that the LTO coated carbon material core particles function as an anode in a LIB. In one embodiment, the LTO particles of the coating layer have an average diameter from about 1 nm to about 1,000 nm. In another embodiment, the LTO particles of the coating layer have an average diameter from about 5 nm to about 500 nm. In yet another embodiment, the LTO particles of the coating layer have an average diameter from about 10 nm to about 250 nm.

The composite anode contains suitable amounts of the carbon material core particles and the coating layer of LTO particles to function as an anode in a LIB. In one embodiment, the composite anode contains from about 80% by weight to about 99.9% by weight of the carbon material core particles and from about 0.1% by weight to about 20% by weight of the coating layer of LTO particles. In another embodiment, the composite anode contains from about 90% by weight to about 99% by weight of the carbon material core particles and from about 1% by weight to about 10% by weight of the coating layer of LTO particles. In yet another embodiment, the composite anode contains from about 92% by weight to about 98% by weight of the carbon material core particles and from about 2% by weight to about 8% by weight of the coating layer of LTO particles.

The LTO particles comprise at least atoms of lithium, titanium, and oxygen. In some instances, small amounts (less than 5% by weight and/or mw) of other atoms can be present, so long as the LTO coated carbon material particles function as an anode in a LIB. In one embodiment, the LTO particles comprise a compound with the formula of LiₓTi_{y}O_{z}, where 0.5≤x≤4, 1≤y≤6, and 1≤z≤12. In another embodiment, the LTO particles comprise a compound with the formula of LiₓTi_{y}O_{z}, where 2≤x≤4, 4≤y≤6, and 4≤z≤12. In yet another embodiment, the LTO particles comprise a compound with the formula Li₄Ti₅O₁₂.

Generally speaking, the composite anode for a LIB is made by coating the carbon material particles having with an LTO precursor and then heating the LTO precursor coated carbon material particles under an inert atmosphere.

In some instances, the composite anode attributes can be further improved by heating the carbon material particles before coating the carbon material with the LTO precursor. Such a heat treatment can cause a surface activation, especially of graphite, and thus can be effective in improving adsorption of the LTO precursor. The heat treatment can be carried out via heating in an oven, heating under a vacuum, sol-gel heating, and/or hydrothermal synthesis. The heating is carried out at a suitable temperature for a suitable period of time to cause surface activation of the carbon material particles. In one embodiment, the heating is carried out at a temperature from about 30° C. to about 95° C. for a time from about 1 hour to about 24 hours. In another embodiment, the heating is carried out at a temperature from about 50° C. to about 90° C. for a time from about 2 hours to about 10 hours.

The LTO precursor is a mixture one or more lithium containing compounds and one or more a titanium containing compounds. The mixture can be a dry powder, a solution, or a slurry. A predetermined weight ratio and/or stoichiometric proportion is/are employed to achieve a desired formula of the LTO.

The lithium containing compound is typically an ionic compound or oxide of lithium, such as an organic lithium salt, an inorganic lithium salt, lithium oxide, or lithium hydroxide. Non-limiting examples lithium containing compounds include lithium fluoride, lithium chloride, lithium bromide, lithium iodide, lithium nitrate, lithium nitrite, lithium sulfate, lithium hydrogen sulfate, lithium sulfite, lithium bisulfite, lithium carbonate, lithium bicarbonate, lithium borate, lithium phosphate, lithium dihydrogen phosphate, lithium hydrogen ammonium phosphate, lithium dihydrogen ammonium phosphate, lithium silicate, lithium antimonate, lithium arsenate, lithium germanate, lithium oxide, lithium alkoxide, lithium enolate, lithium phenoxide, lithium hydroxide, a lithium salt with a carboxylic acid or a hydroxyl carboxylic acid, and combinations thereof. Hydrates of any of these compounds can also be used.

The titanium containing compound is typically an ionic compound or oxide, such as an organic salt or an inorganic salt. Non-limiting examples include titanium dioxide, titanium fluoride, titanium chloride, titanium bromide, titanium iodide, titanium acetyl acetonate, titanium nitrate, titanium nitrite, titanium sulfate, titanium hydrogen sulfate, titanium sulfite, titanium bisulfite, titanium carbonate, titanium bicarbonate, titanium borate, titanium phosphate, titanium hydrogen ammonium phosphate, titanium dihydrogen ammonium phosphate, titanium oxide bis(2,4-pentanadionate), titanium sulfate oxide, titanium silicate, titanium antimonate, titanium arsenate, titanium germanate, titanium oxide, titanium hydroxide, titanium alkoxide, titanium enolate, titanium phenoxide, a titanium salt with a carboxylic acid or a hydroxyl carboxylic acid, and combinations thereof. Hydrates of any of these compounds can also be used.

Coating the carbon material particles with the LTO precursor can be carried out using one or more of a sol-gel coating method, a ball milling coating method, a spray coating method, or a spray drying coating method. Coating is carried out to at least partially surround carbon material particles with the LTO precursor.

After the carbon material particles are coated with the LTO precursor, calcining under an inert atmosphere is conducted for a suitable period of time to provide the composite anode. In one embodiment, the carbon material particles are coated with the LTO precursor are heated at a temperature from about 600° C. to about 850° C. for a time from about 1 hour to about 10 hours. In another embodiment, the carbon material particles are coated with the LTO precursor are heated at a temperature from about 650° C. to about 800° C. for a time from about 2 hours to about 9 hours. In yet another embodiment, the carbon material particles are coated with the LTO precursor are heated at a temperature from about 650° C. to about 800° C. for a time from about 2 hours to about 9 hours. During calcination, the titanium containing compound and the lithium containing compound react to form LTO.

The carbon material particles coated with the LTO precursor are calcined under an inert atmosphere in order to achieve the improved high/low temperature performance and/or improved cycling of the resultant LIBs. An inert atmosphere prevents oxidation during calcination. Non-limiting examples of an inert atmosphere include one or more of argon, helium, neon, argon, krypton, xenon, and nitrogen. Small amounts of other gases (less than 1% by volume) can in many instances be tolerated. Calcining under a vacuum is another example of an inert atmosphere. In another embodiment, the inert atmosphere does not comprise oxygen.

Another aspect of the disclosure involves an anode for a lithium ion battery, containing activating treated surface modified graphite particles. In this aspect, at least one of an inorganic acid or an oxidizing agent is used to treat and modify the surface of the graphite particles. That is, the inorganic acid or oxidizing agent constitutes an activating treatment of the graphite particles as well as modifying the surface of the graphite particles. The activating treatment of the graphite particles and the surface modification of the graphite particles contribute to the improved high/low temperature performance and/or improved cycling of the resultant LIBs.

Graphite includes one or more of natural graphite and synthetic graphites such as electrographite or artificial graphite. The activating treated surface modified graphite particles have a relatively small size which contributes to the beneficial attributes of the LIBs containing the anode. In one embodiment, the activating treated surface modified graphite particles have an average diameter from about 500 nm to about 50 μm. In another embodiment, the activating treated surface modified graphite particles have an average diameter from about 1 μm to about 40 μm. In yet another embodiment, the activating treated surface modified graphite particles have an average diameter from about 5 μm to about 25 μm.

In some instances, the anode attributes can be further improved by heating the graphite particles before contact with an inorganic acid or an oxidizing agent. Such a heat treatment can cause a further surface activation of graphite. The heat treatment can be carried out via heating in an oven, heating under a vacuum, sol-gel heating, and/or hydrothermal synthesis. The heating is carried out at a suitable temperature for a suitable period of time to cause surface activation of the graphite particles. In one embodiment, the heating is carried out at a temperature from about 30° C. to about 95° C. for a time from about 1 hour to about 24 hours. In another embodiment, the heating is carried out at a temperature from about 50° C. to about 90° C. for a time from about 2 hours to about 10 hours.

At least one of an inorganic acid or an oxidizing agent is used to treat and modify the surface of the graphite particles. Non-limiting examples of the inorganic acid and/or the oxidizing agent include one or more of nitric acid, sulfuric acid, phosphoric acid, boric acid, hydrogen chloride, perchloric acid, hypochlorous acid, hydrogen peroxide, sodium hypochlorite, and calcium hypochlorite.

The graphite particles are contacted with at least one of an inorganic acid or an oxidizing agent in solution, typically an aqueous solution. The solution contains a sufficient amount of the at least one of an inorganic acid or an oxidizing agent to provide an activating treatment of the graphite particles and modify the surface of the graphite particles. In one embodiment, the graphite particles are combined with a solution comprising from about 5% by weight to about 90% by weight of the at least one of an inorganic acid or an oxidizing agent. In another embodiment, the graphite particles are combined with a solution comprising from about 25% by weight to about 80% by weight of the at least one of an inorganic acid or an oxidizing agent. In yet another embodiment, the graphite particles are combined with a solution comprising from about 40% by weight to about 70% by weight of the at least one of an inorganic acid or an oxidizing agent.

The graphite particles are contacted with at least one of an inorganic acid or an oxidizing agent for a suitable time and under a suitable temperature to provide an activating treatment of the graphite particles and modify the surface of the graphite particles. In one embodiment, the graphite particles are contacted with at least one of an inorganic acid or an oxidizing agent for a time from about 1 hour to about 3 days under a temperature from about 5° C. to about 70° C. In another embodiment, the graphite particles are contacted with at least one of an inorganic acid or an oxidizing agent for a time from about 2 hours to about 2 days under a temperature from about 15° C. to about 60° C. In yet another embodiment, the graphite particles are contacted with at least one of an inorganic acid or an oxidizing agent for a time from about 3 hours to about 1 day under a temperature from about 20° C. to about 50° C.

After the at least one of an inorganic acid or an oxidizing agent provides the activating treatment of the graphite particles and modifies the surface of the graphite particles, the activating treated surface modified graphite particles are collected and washed. The activating treated surface modified graphite particles can be collected in any suitable manner including, for example, by one or more of filtration, decantation, evaporation, spray drying, and lyophilization.

Washing involves making the activating treated surface modified graphite particles easier to handle, and typically involves rinsing with a solvent such as water. Excess acid, if present, can be removed. Deionized water can be used to minimize deactivation of the activating treated surface modified graphite particles. For example, in one embodiment, the activating treated surface modified graphite particles are rinsed from 1 to about 5 times with deionized water.

LIBs contain a cathode (positive electrode), an anode (negative electrode) as described herein, an electrolyte material, and a separator. LIBs operate by reversibly passing lithium ions between the negative electrode and the positive electrode. A separator and an electrolyte are disposed between the negative and positive electrodes. The electrolyte is suitable for conducting lithium ions and may be in solid or liquid form. Lithium ions move from a positive electrode to a negative electrode during charging of the battery, and in the opposite direction when discharging the battery.

LIBs are used for many applications such as automotive (starters, electrical vehicles, hybrid electrical vehicles), portable consumer devices, tools, uninterruptible power supplies, grid balancing, medical, aerospace, and many other applications.

In the past twenty years, various kinds of carbonaceous materials such as graphite, hard carbon, and soft carbon etc. have been explored as anodes for lithium ion batteries, due to their promising electrochemical performances.

Among the electrochemically active carbon-based materials, graphite is one of the most favorable intercalation host for Li-ion, because of its reasonable cost, low working voltage vs. Li/Li+, and super cycling behavior. Hence, graphite has been widely adopted to be used as the anode material for commercial secondary Lithium ion battery.

In spite of the distinct advantages mentioned above, some intrinsic problems are associated with graphite in battery, including high initial irreversible capacity, unsatisfactory thermal stability. Also, low temperature is always a significant challenge to LIBs. For vehicle and certain defense applications, operation temperatures at −30° C. are required, however, as a common phenomenon, LIBs start to lose most of its capacity and power density when the temperature drops below −10° C. The LIBs with the improved anodes described herein have one or more of the following advantages.

The surface modification technology of the anode material graphite with an inorganic acid or oxidizing agent for an LIB improves the temperature performance is compatible with existing battery manufacturing. The surface modification technology of graphite particles by an inorganic acid or oxidizing agent is also simplified.

In one embodiment, an LIB with the anode described herein at −30° C. has at least 200 mAh/g at 0.2C charging-discharging rate. In another embodiment, an LIB with the anode described herein at −30° C. has at least 225 mAh/g at 0.2C charging-discharging rate. The specific capacity of the LIB with LTO modified graphite as anode material at −30° C. can be at least 242 mAh/g at 0.2C charging-discharging rate.

In one embodiment, initial columbic efficiency of the LIBs with the anodes described herein at ambient temperature is over about 65%. In another embodiment, initial columbic efficiency of the LIBs with the anodes described herein at ambient temperature is over about 75%. In yet another embodiment, initial columbic efficiency of the LIBs with the anodes described herein at ambient temperature is over about 85%.

In one embodiment, the battery capacity retention of an LIB with an anode described herein is over 60% after 300 cycles at 1C charge-discharge rate under 55° C. In another embodiment, the battery capacity retention of an LIB with an anode described herein is over 70% after 300 cycles at 1C charge-discharge rate under 55° C. In yet another embodiment, the battery capacity retention of an LIB with an anode described herein is over 80% after 300 cycles at 1C charge-discharge rate under 55° C.

The anodes described herein were tested as anodes in the form of pouch cells and evaluated regarding to performance capacity at −30° C. and capacity retention after 300 cycles at 55° C. Enhanced cycle life at elevated temperatures and high capacity at low temperatures were shown by the anodes prepared in accordance with the descriptions herein.

The following examples illustrate the subject invention. Unless otherwise indicated in the following examples and elsewhere in the specification and claims, all parts and percentages are by weight, all temperatures are in degrees Centigrade, and pressure is at or near atmospheric pressure.

### Example 1

Graphite having an average particle size of 10 μm with 5% by weight of LTO particles capped as the anode material, Super P as a conductive material, and polyvinylidene fluoride (PVDF) as a binder were mixed in a weight ratio of 90:5:5, and N-methyl pyrrolidone (NMP) was added to the mixture, thereby preparing a slurry. The slurry was strongly stirred by the overhead stirring for ˜2 hours. The prepared anode slurry was coated by doctor blade on a copper current collector to form a film which was then dried in a vacuum oven at 90° C., thereby fabricating an anode.

LiCoO₂ as a cathode active material, Super P as a conductive material and PVDF as a binder was mixed in a weight ratio of 94:3:3, then the mixture was dispersed in N-methyl pyrrolidone (NMP). The prepared dispersion was coated by doctor blade on aluminum foil which was then dried in a vacuum oven at 90° C., thereby fabricating a cathode.

An electrode assembly was fabricated using the thus-fabricated anode and cathode, and a porous polypropylene separator placed between them. The electrode assembly was placed in a pouch-type case to which electrode leads were then connected. Thereafter, an electrolyte solution was injected the case, followed by hermetically hot sealing the battery case to finish the fabrication of a lithium secondary battery.

### Example 2

In order to modify the surface of graphite particles, graphite were added in a 65 wt % nitric acid bath then the slurry was stirred at 500 rpm on a magnetic stirrer for 24 hours. Finally, graphite particles in nitric acid were collected by filter paper and washed 3 times with DI water then dried.

A lithium secondary battery was fabricated in the same manner as in Example 1, except that graphite particles pretreated by 65 wt % nitric acid as noted in the paragraph above functionalized as an anode material.

With respect to any figure or numerical range for a given characteristic, a figure or a parameter from one range may be combined with another figure or a parameter from a different range for the same characteristic to generate a numerical range.

Other than in the operating examples, or where otherwise indicated, all numbers, values and/or expressions referring to quantities of ingredients, parameters, measurements, reaction conditions, etc., used in the specification and claims are to be understood as modified in all instances by the term “about.”

While the invention is explained in relation to certain embodiments, it is to be understood that various modifications thereof will become apparent to those skilled in the art upon reading the specification. Therefore, it is to be understood that the invention disclosed herein is intended to cover such modifications as fall within the scope of the appended claims.

What is claimed is:

1. A composite anode for a lithium ion battery, comprising:
carbon material core particles having an average diameter from about 500 nm to about 50 μm; and
a coating layer of lithium titanium oxide (LTO) particles over the carbon material core particles, the LTO particles having an average diameter from about 1 nm to about 1,000 nm, the coating layer of LTO particles at least partially covering the carbon material core particles.

2. The composite anode according to claim 1, wherein the carbon material core particles comprise graphite.

3. The composite anode according to claim 1, comprising from about 80% by weight to about 99.9% by weight of the carbon material core particles and from about 0.1% by weight to about 20% by weight of the coating layer of LTO particles.

4. The composite anode according to claim 1, wherein the LTO particles comprise a compound with the formula of LiₓTi_{y}O_{z}, where 0.5≤x≤4, 1≤y≤6, and 1≤z≤12.

5. The composite anode according to claim 1, wherein the LTO particles comprise a compound with the formula Li₄Ti₅O₁₂.

6. The composite anode according to claim 1, wherein the coating layer of LTO particles covers at least 50% of the surface area of the carbon material core particles.

7. The composite anode according to claim 1, wherein the coating layer of LTO particles covers substantially the entire surface area of the carbon material core particles.

8. A lithium ion battery comprising a cathode and the composite anode according to claim 1.

9. A method of making a composite anode for a lithium ion battery, comprising:
coating carbon material particles having an average diameter from about 500 nm to about 50 μm with a lithium titanium oxide (LTO) precursor;
calcining the LTO precursor coated carbon material particles under an inert atmosphere to provide the composite anode.

10. The method of making a composite anode according to claim 9, further comprising:
heating the carbon material particles before coating the carbon material particles.

11. The method of making a composite anode according to claim 9, wherein coating the carbon material particles comprises one of a sol-gel coating method, a ball milling coating method, a spray coating method, or a spray drying coating method.

12. The method of making a composite anode according to claim 9, wherein calcining comprises heating at a temperature from about 600° C. to about 850° C. for a time from about 1 hour to about 10 hours.

13. The method of making a composite anode according to claim 9, wherein the inert atmosphere consists essentially of one or more of argon, helium, neon, argon, krypton, xenon, and nitrogen.

14. The method of making a composite anode according to claim 9, wherein the inert atmosphere does not comprise oxygen.

15. An anode for a lithium ion battery, comprising:
activating treated surface modified graphite particles having an average diameter from about 500 nm to about 50 μm, wherein at least one of an inorganic acid or an oxidizing agent is used to treat and modify the surface of the graphite particles.

16. The anode according to claim 15, wherein the inorganic acid and the oxidizing agent are selected from the group comprising nitric acid, sulfuric acid, phosphoric acid, boric acid, hydrogen chloride, perchloric acid, hypochlorous acid, hydrogen peroxide, sodium hypochlorite, calcium hypochlorite, and combinations thereof.

17. A lithium ion battery comprising a cathode and the anode comprising the activating treated surface modified graphite particles according to claim 15.

18. A method of making the activating treated surface modified graphite particles according to claim 15, comprising:
combining graphite particles having an average diameter from about 500 nm to about 50 μm with a solution comprising from about 5% by weight to about 90% by weight of the at least one of an inorganic acid or an oxidizing agent for a time from about 1 hour to about 3 days under a temperature from about 5° C. to about 70° C., and
collecting and washing the activating treated surface modified graphite particles.

19. The method according to claim 18, wherein the solution comprises from about 40% by weight to about 80% by weight of the at least one of an inorganic acid or an oxidizing agent.

20. The method according to claim 18, wherein the solution comprises at least one selected from the group comprising nitric acid, sulfuric acid, phosphoric acid, boric acid, hydrogen chloride, perchloric acid, hypochlorous acid, hydrogen peroxide, sodium hypochlorite, and calcium hypochlorite.
